(19) United States
(12) Patent Application Publication
(10) Pub. No.: US 2010/0097312 A1
(43) Pub. Date: Apr. 22, 2010

(54) SYSTEM AND METHOD FOR LIGHT CONTROL

(75) Inventors: Galileo June Destura, Eindhoven (NL); Jan Tatousek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,714

(22) PCT Filed: Oct. 9, 2007
(86) PCT No.: PCT/IB2007/054094

§ 371 Date: Apr. 8, 2009

(30) Foreign Application Priority Data
Oct. 12, 2006 (EP) 06122147.9

(51) Int. Cl. G09G 5/00

(52) U.S. Cl. 345/156

(57) ABSTRACT

A system for light control, comprising a light source (4) for illuminating an area (10), a pointer device (6) for projecting location information (11) on the area (10), and a receiver (5) for detecting the location information (11), wherein the system is configured to determine the position of the locations information (11) on the area (10), and a controller is configured to control illumination of the area (10), depending on said location information (11).

### TECHNICAL FIELD OF THE INVENTION

The present invention relates to a system for light control and comprises a light source for illuminating an area and a pointer device for projecting location information on the area.

### TECHNICAL BACKGROUND

The introduction of LED (light emitting diode) based light sources and associated systems that allow produced light to be steered towards a particular direction, provides new opportunities in respect of how light is generated. A related issue is how a user might be able to instruct a light source to only illuminate a particular area.

WO2005/013646, for example, discloses an illumination control system having two illumination devices and an illuminance comparison device. The comparison device compares an illuminance at an arbitrary position with a desired, predefined illuminance and sends the comparison result to the illumination devices. The two illumination devices make adjustments according to the comparison result acquired from the comparison device, and increase or decrease the light intensity of the respective illumination devices so as to control the illuminance at the arbitrary position. By using this illumination control system it is possible to set a desired illuminance for a predetermined position.

However, one problem with prior art devices is that user interaction with the light sources is complicated.

### OBJECTS OF THE INVENTION

It is an object of the present invention to provide an improvement of the above techniques and prior art.

A particular object is to improve the user-friendliness of a system for light control.

### SUMMARY OF THE INVENTION

These and other objects and advantages that will be apparent from the following description of the present invention are achieved by a system and a method according to the respective independent claims. Preferred embodiments are defined in the dependent claims.

Hence a system for light control is provided, which comprises a light source for illuminating an area, a pointer device for projecting location information on the area, a controller and a receiver for detecting the location information, wherein the system is configured to determine the position of the locations information on the area, and configured to control illumination of the area, depending on said location information.

The inventive system is advantageous in that user interaction with the system is improved, and in that the system may be employed for several applications, such as for video projectors where the illuminated area is the surface were an image is projected. Moreover, it is possible to assemble the system out of standard components, which provides a low cost solution. The inventive system may also be fitted on various present light source applications.

The location information may be projected as a two-dimensional symbol on the area, which improves the receiver detection of the location information.

The projection of the location information may involve moving the location information on the area according to a two-dimensional figure, and the controller may be configured to interpret the motion pattern of the location information, which provides for different and dynamic user input commands.

The light source may be configured to selectively vary illumination properties for sub-areas of the area, which facilitates highly versatile illumination of the area.

The light source may also be configured to project visible light on the area, at the position of the location information, for providing a flexible and selectable visualization of the location information.

The pointer device may be a hand held unit for offering user convenience, and the light source, the receiver and the control unit may be assembled as one unit for providing a compact design.

The receiver may comprise a wavelength filter for detecting the location information, and it may also comprise a field of detection, which is greater than the illuminated area, which further improves user friendliness as well as a more robust system.

The light source may comprise light emitting diodes and means for directing light from at least one of the light emitting diodes, for facilitating, for example, specific illumination of a sub-area of the illuminated area.

According to another aspect of the invention, a method of controlling light is provided, which comprises the steps of: illuminating an area by a light source; projecting location information on the area by a pointer device; detecting the location information by a receiver; determining the position of the locations information on the area; and controlling illumination of the area, depending on said location information.

The location information of the method may, as with the inventive system, be projected as a two-dimensional symbol on the area.

The step of projecting the location information may involve moving the location information on the area according to a two-dimensional figure and interpreting, by the controller, the motion pattern of the location information.

The method may further comprise the step of selectively varying, by the light source, illumination properties for sub-areas of the area.

The method may further comprise the step of projecting visible light, by the light source, on the area at the position of the location information.

The inventive method may incorporate any of the features described above in association with the inventive system, and has the same corresponding advantages

According to yet another aspect of the invention, a pointer device is provided for use in the inventive system incorporating any of the features above.

### BRIEF DESCRIPTION OF THE DRAWING

Embodiments of the present invention will now be described, by way of example, with reference to the accompanying schematic drawings, in which

FIG. 1 is a schematic illustration of the inventive system,

FIG. 2 is a schematic illustration of an illumination unit, and

FIG. 3 is a schematic illustration of a pointer device.

### DETAILED DESCRIPTION OF PREFERRED EMBODIMENTS OF THE INVENTION

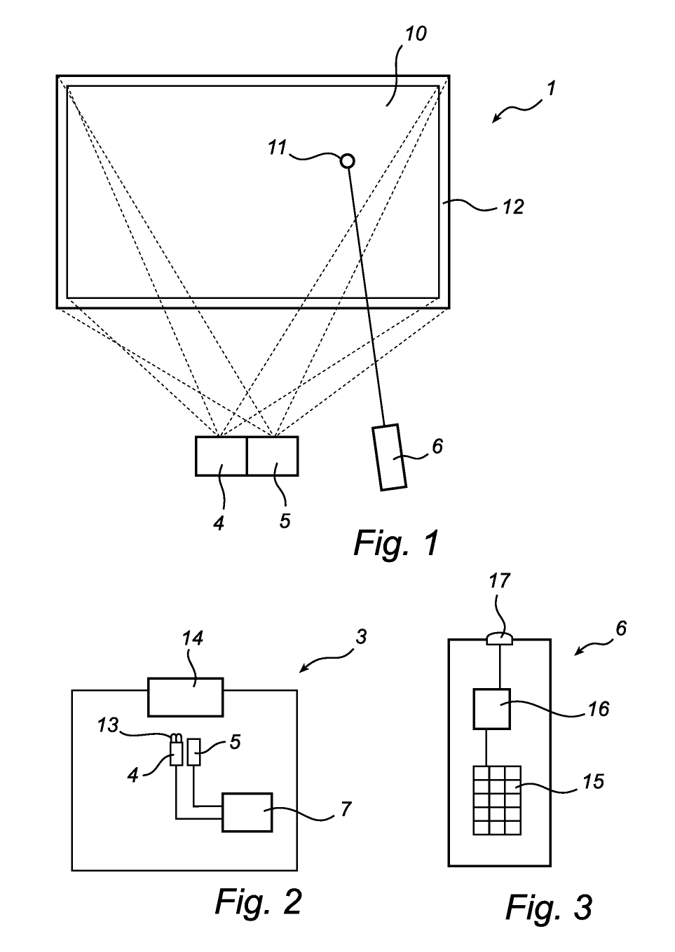

FIG. 1 illustrates a system for light control and comprises a light source 4, a receiver 5 and a pointer device 6. The pointer device 6 is used for pointing on an area 10 generated by the light source 4 on, for example, a projector screen. The pointer devices 6 projects location information 11 on the area 10 by emitting a ray of light in a direction towards the area 10.

The receiver 5 has a detection area 12, which coincides with, and is preferably greater than, the illuminated area 10. The receiver 5 is in a conventional manner capable to detect the location information 11 projected at the detection area 12, and to determine the position of the location information 11 on the detection area 12.

FIG. 2 illustrates the light source 4 and the receiver 5 assembled in one unit 3. A control unit 7 is connected to and controls the light source 4 and the receiver 5. Light from the light source 4 and the field of detection of the receiver 5 are in any known and suitable way projected by means of optics 14 arranged in the unit 3, such that a fix relationship between the projected light and the field of detection is created. It should be noted that even if the area 10 and the detection area 12 are illustrated in FIG. 1 as being offset, they preferably have the same point of emittance. The light source typically comprises a plurality of LEDs 13 and means, e.g. movable mirrors (not shown), arranged for steering light from one of the LEDs 13.

During operation, the receiver 5 continuously provides the control unit 7 with signals representative of the location information's 11 position on the detection area 12, and the control unit determines, since the relationship between the area 10 and the detection area 12 is known, the location of the position of the locations information 11 on the area 10.

FIG. 3 illustrates the pointer device 6 which has a keyboard 15 connected to a pointer control unit 16, which in turn is connected to a light source 17 that emits light in the form of location information 11. The emitted light has a specific wavelength or pulse code and the receiver 5 is configured to detect this wavelength/pulse code. The keyboard 15 provides for various user input commands that are wirelessly transmitted to the unit 3.

The light source 4, receiver 5, control unit 7, pointer light source 17 and pointer control unit 16 are each respectively assembled in a conventional manner, and any known receiver/pointer combination may be used, as long as the receiver 5 may detect the location information 11 projected by the pointer 6.

As mentioned, the light source 4 comprises sets of LEDs 13 for generating light on a sub-area of the whole area 10 covered by the combined light source 4 and receiver 5.

Moreover, the system is configured to, in a conventional manner, use the pointer device 6 pointed to the detection area 12 for controlling the light properties of the area 10, and to indicate the pointed position 11 by means of the light source 4.

The control unit 7 is in a conventional manner arranged to associates the position, or series of positions, of the location information 11 with a predetermined command related to the displayed area 10.

It is also possible to arrange the receiver in the pointer device 6 and the location information projector in the unit 3. In this case the pointer device 6 incorporates standard communication means, e.g. radio frequency means, such that the determined pointed location can be transmitted back to the unit 3, and the optical arrangement of both the receiver and location information projector is configured in such a way that illuminated area 10 is always the reference point. In brief, if the unit 3 incorporates the projector for location information, then the pointer device 6 will only receive “detectable” location information when it is pointed to area 10. Of course, when the receiver is arranged in the pointer device 6 and the location information is projected by the unit 3, the pointer control unit 16 controls the receiver, and the control unit 7 controls the location information projector.

In other words, the unit comprises a light source system, such as a set of LEDs, and related known beam steering means, such as steerable mirrors, for illuminating a particular area and have the ability to selectively illuminate a sub-area of the said particular area. The unit further comprises a pointed location system unit that projects a location information on the said particular area. The location information is then detected by the receiver's detection sensor and is relayed back to the pointed location system. The pointed location system preferably controls the light source to produce a pointed location indicator, e.g. a light spot, on the pointed location within the said particular area, for purpose of user feedback. The pointed location indicator may also be provided by the pointer light source, in case of the pointer light source emitting visible light.

Gestures, such as a circling motion, is then used to indicate the sub-area wherein specific illumination is desired. A further gesture may be made to further suggest changing the light property. An example of this is that drawing the letter ‘C’ inside the sub-area may indicate that the user wants to change the color of the illumination on the mentioned sub-area.

Alternatively, certain choices of color presets can be presented to the user on the mentioned particular area in such a manner that the user may be able to select the preferred preset.

The invention does not only apply to the pointing location system being used in combination with a set of LEDs used for light illumination purposes, but the pointing location system may also be used in combination with any suitable display projector.

1. A system for light control, comprising
a light source for illuminating an area,
a pointer device for projecting location information on the area,
a controller, and
a receiver for detecting the location information, wherein the system is configured to:
determine the position of the locations information on the area, and
control illumination of the area, depending on said location information.

2. A system according to claim 1, wherein the location information is projected as a two-dimensional symbol on the area.

3. A system according to claim 1, wherein projecting the location information comprises moving the location information on the area according to a two-dimensional pattern, the controller being configured to interpret the movement of the location information.

4. A system according to claim 1, wherein the light source is configured to selectively vary illumination properties for sub-areas of the area.

5. A system according to claim 1, wherein the light source is configured to project visible light on the area at the position of the location information.

6. A system according to claim 1, wherein the pointer device is a hand held unit.

7. A system according to claim 1, wherein the light source, the receiver and the control unit are assembled as a single unit.

8. A system according to claim 1, wherein the receiver comprises a wavelength filter for detecting the location information.

9. A system according to claim 1, wherein the receiver comprises a field of detection, which is greater than the illuminated area.

10. A system according to claim 1, wherein the light source comprises light emitting diodes and means for directing light from at least one of the light emitting diodes.

11. A method of controlling light, said method comprising the steps of:
illuminating an area by a light source,
projecting location information on the area by a pointer device,
detecting the location information by a receiver,
determining the position of the locations information on the area, and
controlling illumination of the area, depending on said location information.

12. A method according to claim 11, wherein the location information is projected as a two-dimensional symbol on the area.

13. A method according to claim 11, wherein the step of projecting the location information comprises moving the location information on the area according to a two-dimensional pattern, and interpreting, the motion pattern of the location information.

14. A method according to claim 11, further comprising the step of selectively varying, by the light source, illumination properties for sub-areas of the area.

15. A method according to claim 11, further comprising the step of projecting visible light, by the light source, on the area at the position of the location information.

16. (canceled)
